(19) United States
(12) Patent Application Publication
(10) Pub. No.: US 2019/0160480 A1
(43) Pub. Date: May 30, 2019

(54) SQUEEZE SPRAYER CLOSURE

(71) Applicant: RIEKE PACKAGING SYSTEMS LIMITED, Leicestershire (GB)

(72) Inventor: Yen Kean LEE, Rohnert Park, CA (US)

(21) Appl. No.: 16/093,337

(22) PCT Filed: Apr. 4, 2017
(86) PCT No.: PCT/EP2017/057929

§ 371 Date: Oct. 12, 2018

Related U.S. Application Data
(60) Provisional application No. 62/323,025, filed on Apr. 15, 2016.

(51) Int. Cl. B05B 11/00; B05B 1/34; B05B 11/04

(52) U.S. Cl. CPC B05B 11/0059; B05B 1/3436; B05B 11/043; B05B 11/007; B05B 11/0032

(57) ABSTRACT

An inverted squeeze sprayer for dispensing liquid product is a spray mist includes a squeeze bottle and a squeeze sprayer closure (22) attached to the squeeze bottle. The squeeze sprayer closure includes a cap (26) which defines a chamber (70) for receipt of air and liquid and further defines an outlet (64). Further included as a part of the squeeze sprayer closure is a valve (28) which is assembled into the squeeze sprayer cap and a dip tube (30) which is received by the squeeze sprayer cap. The dip tube is constructed and arranged to provide air to the chamber and the squeezing of the bottle forces air and liquid into the chamber and from there through the outlet to be dispensed as a spray mist.

### BACKGROUND

The broad category of “product dispensers” includes dispensers for particulate matter as well as for flowable material. Within the subset of flowable product dispensers one will find lotion dispensers and foam dispensers, as a couple of examples. Another type of fluid dispenser for flowable product would be a sprayer pump or trigger sprayer. The product which is dispensed from this type of structure is often the result of atomization with the selected liquid product being delivered as a mist or spray.

Atomization of a liquid product is commonly achieved by the use of a pump sprayer mechanism with a trigger member (i.e. a “leveler”), thus a trigger sprayer. The pump engine of the trigger sprayer is able to achieve high back pressure and thereby increase the flow velocity to achieve atomization. Often pump sprayer mechanisms, such as trigger sprayers and finger mist sprayers, find it necessary to use his many as 6 to 9 component parts in their construction. For cost saving reasons, it would be an improvement to spray mist dispensers if the overall component part count could be reduced.

Mist dispensers can also be constructed as a squeeze bottle dispenser (i.e. squeeze sprayer). In this category of spray dispenser or spray mist dispenser, it is the manual squeezing of the bottle, rather than the use of a trigger member/mechanism, which creates the requisite pressure for the necessary flow velocity to achieve atomization of the liquid product.

One consideration as a part of the design for squeeze sprayers is whether it will be used as an upright mist dispenser or will be used as an inverted mist dispenser. In the case of an inverted mist dispenser, there can be a design issue in terms of dripping of the liquid product when the dispenser is inverted and the bottle is not squeezed for an extended period of time. It would be an improvement to the design of inverted squeeze sprayers if a way could be found to mitigate dripping of liquid product when the squeeze sprayer is inverted and not squeezed for an extended period of time.

### SUMMARY

The disclosed squeeze sprayer closure is constructed and range to be used with a squeeze bottle. The disclosed squeeze sprayer which is the assembled combination of the disclosed squeeze sprayer closure and the illustrated squeeze bottle, is intended to be used as an inverted squeeze sprayer. One design consideration for a suitable and in fact a preferred squeeze sprayer closure is the number of component parts which are required. As the number of component parts is reduced, particularly for plastic parts, the number of different molds or different mold cavities is correspondingly reduced and the assembly time is reduced, even if automated. Another design consideration for a suitable and in fact preferred inverted squeeze sprayer is how to mitigate dripping of liquid product when the squeeze sprayer is inverted and not squeezed for an extended period of time.

These two design considerations are addressed by the disclosed squeeze sprayer closure in novel and unobvious ways. For the desirability of a reduced number of component parts, one embodiment of the disclosed squeeze sprayer closure has only three component parts. An alternative embodiment adds a fourth component part. One of the component parts is a diaphragm valve (two way) and another component part is a dip tube. The diaphragm valve is a two-way valve and is provided as one of the three parts for the mitigation of possible dripping of liquid product. The remaining structure of the disclosed squeeze sprayer closure is found in the novel and unobvious flip-top cap which includes a unique chamber design to facilitate the mixing of liquid product and air to facilitate the generation of a spray mist which is dispensed upon squeezing of the bottle.

Further forms, objects, features, aspects, benefits, advantages, and embodiments of the present invention will become apparent from a detailed description and drawings provided herewith.

In one aspect the invention provides a squeeze sprayer for dispensing liquid product as a spray mist, said squeeze sprayer comprising:

a squeeze bottle;

a squeeze sprayer cap received by said squeeze bottle and defining a chamber, for receipt of air and liquid, and an outlet for spray formed from the air and liquid;

a valve assembled into said squeeze sprayer cap; and

a dip tube received by said squeeze sprayer cap, said dip tube providing air to said chamber, wherein squeezing of said bottle forces air and liquid into said chamber and then through said outlet as a spray mist.

The squeeze sprayer cap may have a single-piece construction. It may include a flip-top lid, preferably as part of a single-piece construction. It may include an annular sleeve, which may receive the dip tube. It may include a panel which defines a dispensing outlet.

The valve may be a diaphragm valve. It may comprise a flexible panel with a hole through which the dip tube extends, engaging the dip tube with an annular lip. The annular lip is deflected to allow flow when the bottle is squeezed. It may be comprised in a valve component which fixes to the squeeze sprayer cap. The component may have an annular wall which secures in a channel of the squeeze sprayer cap. Desirably the valve component is a one-piece component comprising the wall and the panel; typically the wall is thicker than the panel. It may be of elastomeric material. The valve component may enclose the entry to a liquid flow channel leading to the chamber where the air and liquid mix.

A liquid flow channel through which liquid enters the chamber may be defined between a portion of said squeeze sprayer cap, such as a sleeve which holds the dip tube, and the dip tube. There may be two or more liquid flow channels around the chamber, which may be central. The flow channel(s) may be shaped to cause rotational liquid flow in the chamber.

### BRIEF DESCRIPTION OF THE DRAWINGS

FIG. 1 is a perspective view of an inverted squeeze sprayer according to an exemplary embodiment of the present invention.

FIG. 2 is a fragmentary, side elevational view of the FIG. 1 inverted squeeze sprayer.

FIG. 3 is a front elevational view, in full section, of a squeeze sprayer closure, in a closed condition, which comprises one part of the FIG. 1 inverted squeeze sprayer.

FIG. 3A is an enlarged detail of a chamber of the FIG. 3 squeeze sprayer closure which chamber leads to a dispensing outlet.

FIG. 3B is an enlarged detail of a threaded wall of the FIG. 3 squeeze sprayer closure.

FIG. 4 is an exploded view of the FIG. 3 squeeze sprayer closure, turned to an upright orientation.

FIG. 5 is a front elevational view of a flip-top cap, with the lid hinged open, which comprises one part of the FIG. 3 squeeze sprayer closure.

FIG. 6 is a right side elevational view of the FIG. 5 flip-top cap.

FIG. 7 is a left side elevational view of the FIG. 5 flip-top cap.

FIG. 8 is a rear elevational view of the FIG. 5 flip-top cap.

FIG. 9 is a top plan view of the FIG. 5 flip-top cap.

FIG. 10 is a right side elevational view, in full section, of the FIG. 3 squeeze sprayer closure, in an open condition.

FIG. 11 is a front elevational view, in full section, of a valve which comprises one part of the FIG. 3 squeeze sprayer closure.

FIG. 12 is a front elevational view, in full section, of a dip tube which comprises one part of the FIG. 3 squeeze sprayer closure.

FIG. 13 is a bottom plan view of the FIG. 10 squeeze sprayer closure in an open condition.

FIG. 14 is an enlarged detail of the chamber which is part of the flip-top cap.

### DESCRIPTION OF THE SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

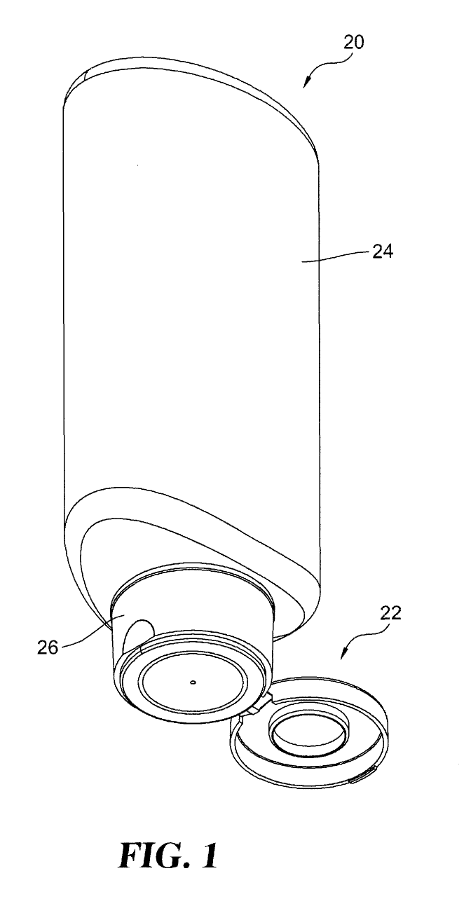

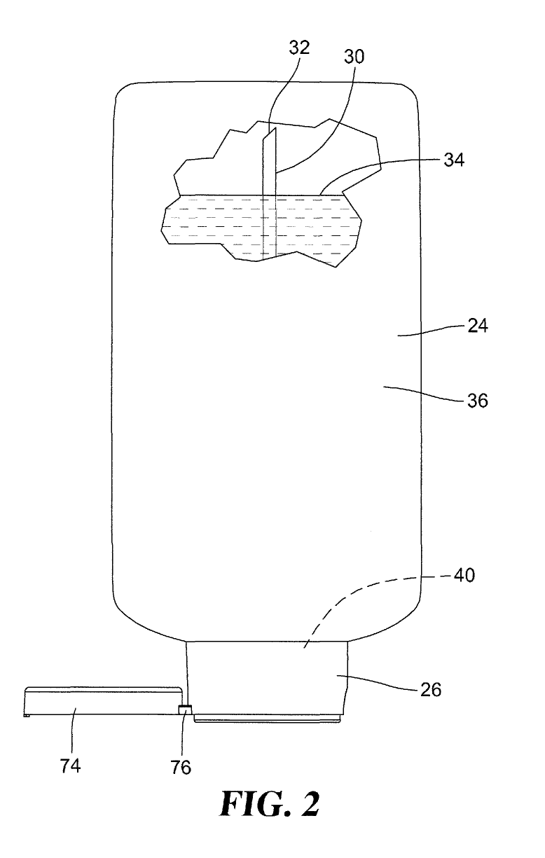

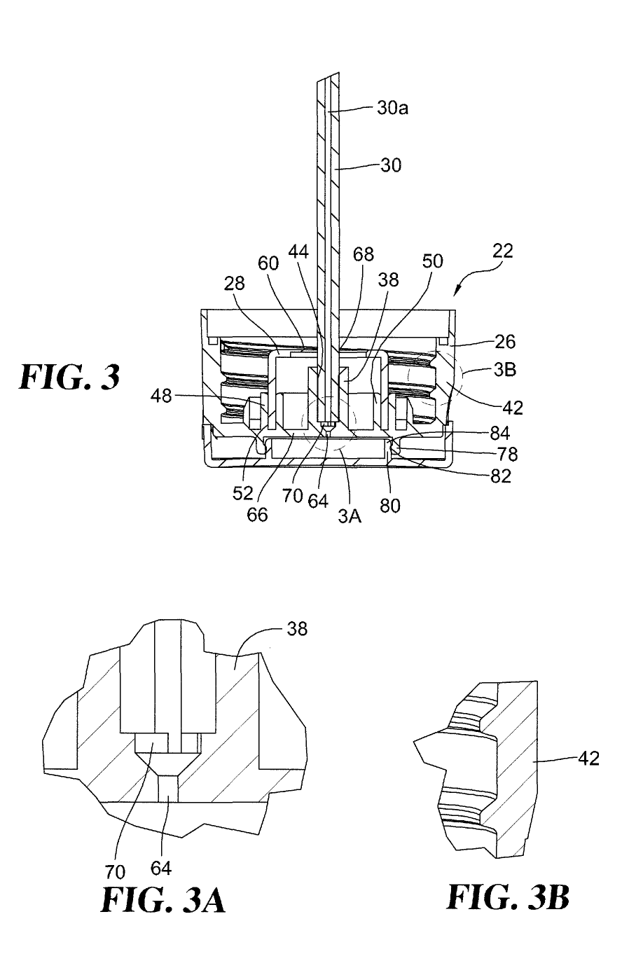

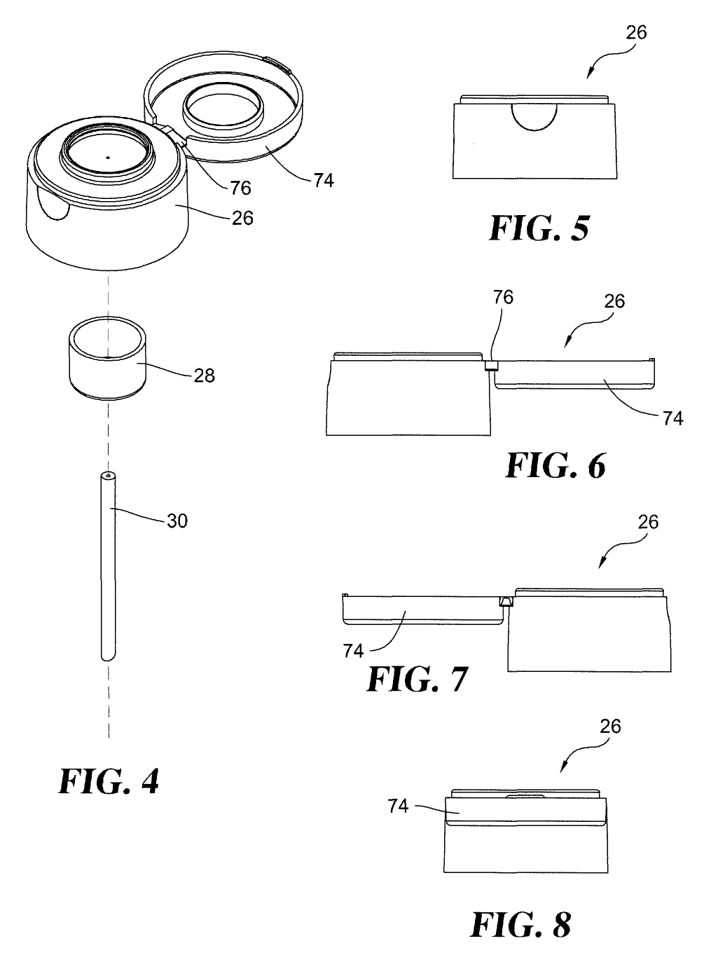

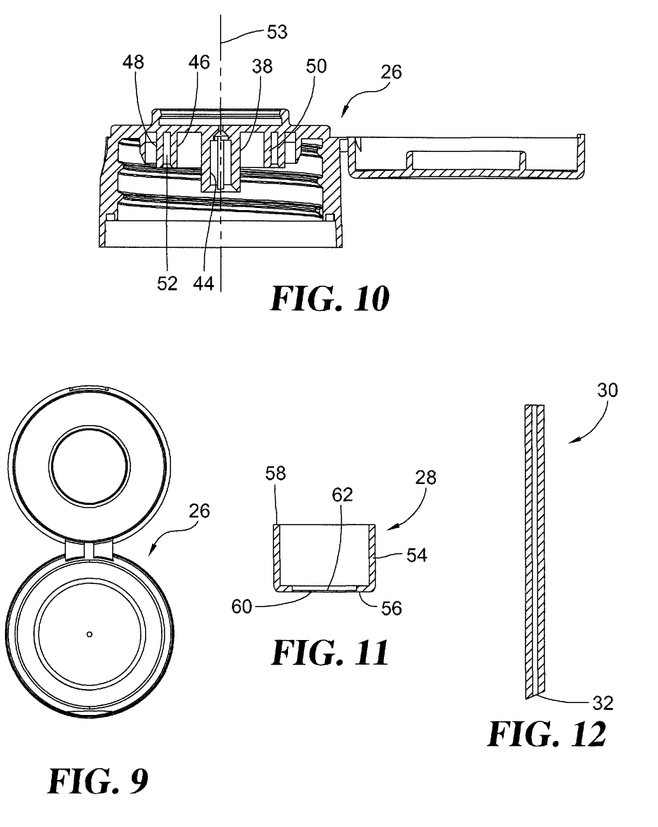

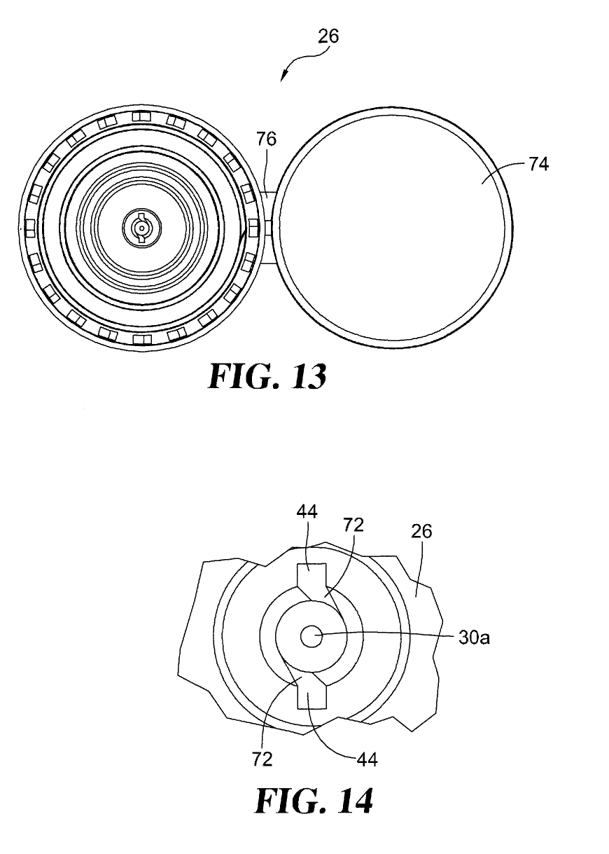

Referring to FIGS. 1 and 2, there is illustrated a squeeze sprayer 20 which includes the assembled combination of squeeze sprayer closure 22 and squeeze bottle 24. The squeeze sprayer closure 22 (see FIGS. 3, 3A, 3B and 4) includes a squeeze sprayer flip-top cap 26, a two-way diaphragm valve 28 and a dip tube 30. The intended use of squeeze sprayer 20 is preferably in an inverted position, as illustrated, with the closure 22 position below the bottle 24 (see FIGS. 1 and 2). In this inverted orientation the inlet 32 of the dip tube 30 is positioned above the liquid level 34 such that air is drawn into the dip tube 30 from the headspace of bottle 24. Squeezing inwardly on the side wall 36 of bottle 24 (manual squeezing) forces air through the dip tube 30 and forces liquid into the annular sleeve 38 of the flip-top cap 26. The specific flow path for the liquid upon squeezing of bottle 24 is between the inner surface of annular sleeve 38 and the outer surface of dip tube 30, see FIG. 3. In the exemplary embodiment the annular neck 40 of bottle 24 is externally threaded. The inner surface of the annular outer wall 42 of flip-top cap 26 is internally threaded in a corresponding and cooperative manner, see FIGS. 3 and 3B. This cooperative threaded construction allows the flip-top cap 26 to be threaded onto the bottle neck 40 for the secure assembly of the flip-top cap 26 and bottle 24.

With continued reference to FIGS. 3, 3A and 4, the component parts which comprise closure 22 are illustrated both as an assembly (FIG. 3) and as an exploded view (FIG. 4). Closure 22, as stated, includes the assembly of flip-top cap 26, two-way diaphragm valve 28 and dip tube 30. The dip tube 30 which preferably has a substantially cylindrical form is received within annular sleeve 38 of cap 26. A moderate level of interference fit is selected as the way to retain the dip tube 30 in this assembled condition within sleeve 38. This interference fit is not required for the full axial length of sleeve 38, only enough area of interference fit to retain the dip tube 30 in this retained position. However, as noted above, there needs to be a liquid flow path between the dip tube 30 and sleeve 38. In the exemplary embodiment this flow path is achieved by providing one or more liquid flow channels 44 in the body of sleeve 38, facing the dip tube 30. For the purposes of the exemplary embodiment, two liquid flow channels 44 are provided. In an alternative form of the exemplary embodiment four liquid flow channels 44 are provided.

Flip-top cap 26 includes an annular inner wall 46 which is substantially concentric with annular sleeve 38. Inner wall 46 includes an annular, radially outer portion 48 and an annular, radially inner portion 50 which together defined therebetween annular channel 52. Preferably, cap 26 has a substantially cylindrical form, at least in part with its primary structural portions each being substantially cylindrical, as well as substantially concentric such that the axial centerline of the cap 26 is the axial centerline 53 of the sleeve 38 and of the inner wall 46.

The two-way diaphragm valve 28 has a substantially cylindrical form with an annular wall 54, and annular, partially closed end 56 and an annular open end 58. The open end 58 is inserted into annular channel 52 with a moderate interference fit. This moderate interference fit is sufficient for the channel 52 to retain the valve 28 in this assembled condition. The partially closed end 56 includes a central panel 60 with a small pilot hole 62 for receipt of the dip tube 30. Panel 60 has a thickness which is less than the remainder of closed end 56, thereby adding greater flexibility to panel 60. The valve 28 is preferably a single-piece component fabricated out of an elastomeric material. Providing an increased wall thickness for wall 54 compared to panel 60 enables end 58 to have sufficient rigidity to be inserted into channel 52 with the moderate interference fit as previously described. The panel 60 though is more flexible allowing it to flex and deflect (i.e. open) in response to the increased pressure due to squeezing of the bottle 24 in order to permit the flow of liquid. While the valve 28 could be made from two pieces, one for the more rigid body and the other piece for the flexible panel, this would increase the number of component parts and logically, likely increase the overall cost.

When the dip tube 30 is pushed through the pilot hole 60 in order to insert the dip tube 30 into sleeve 38, the annular portion of panel 60 which immediately surrounds the pilot hole 62 flexes and deflects in the direction of sleeve 38. This annular portion lays up snugly against the outer surface of the dip tube 30. When there is an interior pressure increase due to the manual squeezing of the bottle 24, air from the headspace of the inverted bottle is forced into inlet 32 and travels to dispensing outlet 64 which is defined by panel 66 of cap 26. Concurrently, liquid from within bottle 24 is forced against panel 60. The deflected annular lip 68 resulting from the surrounding annular portion of panel 60 opens slightly creating a clearance flow passage between lip 68 and the outer surface of the dip tube 30. This flow of liquid ultimately reaches the flow channels 44 (whether two channels in one embodiment or four channels in the other embodiment) and flows into chamber 70 which is positioned between the interior of sleeve 38 and dispensing outlet 64. As soon as the pressure is released, such that the liquid flow ends, the annular lip 68 returns to its sealed condition against the dip tube 30. This rapid closure prevents any suck back and mitigates any dripping.

Flip-top cap 26 is preferably a single-piece, molded plastic component. As such, there is no specific line which denotes the boundary line between the sleeve 38 and panel 66. For the purposes of this disclosure it will be assumed that panel 66 has a substantially uniform thickness as it extends across inner portion 50. Accordingly, dispensing outlet 64 is described as being defined by panel 66 and chamber 70 is defined by sleeve 38. The hollow interior 30a of dip tube 30 opens directly into chamber 70 and chamber 70 opens directly into dispensing outlet 64.

Chamber 70 is in liquid flow communication with the flow channels 44 such that both air and liquid flow together before this combination exits under pressure through outlet 64 as a spray mist. With reference to FIGS. 3A and 14, it will be seen that as the liquid flow channels 44 open into chamber 70, there is a flow corridor extension 72 coming off of the end of each channel 44. Each flow corridor extension 72 creates a part-circular liquid flow rotation around the end opening of the dip tube 30. The combination of the liquid flow rotation and the airflow at high velocity all within chamber 70 results in the dispensing of a spray mist from dispensing outlet 64, something which occurs promptly upon the manual squeezing of bottle 24.

Cap 26 includes as part of its single-piece construction a hinged lid 74 which is constructed and arranged to close over panel 66 and close off outlet 64. A living hinge 76 is used to connect lid 74 to the remainder of cap 26. The securement of lid 74 on to the remainder of cap 26 and its close condition is by a snap-fit interfit. Panel 66 includes an annular wall extension 78 and lid 74 includes a cooperating annular wall 80. The wall extension 78 includes a small annular bead 82 on its inner surface. The wall 80 includes a cooperating annular bead 84 on its outer surface for the snap-fit closing of lid 74, as illustrated in FIG. 3, is based on the snap over between cooperating annular beads 82 and 84.

While the exemplary embodiment of the present invention has been disclosed and described as an inverted squeeze sprayer, it is important to note that the disclosed construction can be used at an inversion angle. Use in an inversion angle might be something which would be beneficial as a part of alternatively shaping the bottle into a different geometry. If the bottle is more ergonomic at an angle, for example, then use of the disclosed squeeze sprayer at an inversion angle is possible.

It is also technically possible to use the disclosed squeeze sprayer in an upright condition, though it is expected that the nature of the spray mist which would result might not satisfy all commercial needs or expectations. From a technical perspective, an upright usage reverses the airflow path and the liquid flow path. While these two constituents still come together in chamber 70, it is the high velocity of air flow which helps to create the desired spray mist in the exemplary embodiment. When the two flows are reversed, instead of having air at a high velocity one would have liquid at a high velocity. When liquid is delivered by way of the dip tube and the flows of air are rotated in chamber 70, the nature of the spray mist will be different, yet likely acceptable for limited uses.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected. All publications, patents, and patent applications cited in this specification are herein incorporated by reference as if each individual publication, patent, or patent application were specifically and individually indicated to be incorporated by reference and set forth in its entirety herein.

1. An inverted squeeze sprayer for dispensing liquid product as a spray mist, said squeeze sprayer comprising:
a squeeze bottle;
a squeeze sprayer cap received by said squeeze bottle and defining a chamber for receipt of air and liquid and an outlet;
a valve assembled into said squeeze sprayer cap; and
a dip tube received by said squeeze sprayer cap, said dip tube providing air to said chamber, wherein squeezing of said bottle forces air and liquid into said chamber and then through said outlet as a spray mist.

2. The squeeze sprayer of claim 1 wherein said squeeze sprayer cap has a single-piece construction which includes an annular sleeve.

3. The squeeze sprayer of claim 2 wherein said annular sleeve defines said chamber.

4. The squeeze sprayer of claim 2 wherein said annular sleeve receives said dip tube.

5. The squeeze sprayer of claim 1 wherein said squeeze sprayer cap includes a panel which defines a dispensing outlet.

6. The squeeze sprayer of claim 1 wherein said squeeze sprayer cap includes a flip-top lid as a part of said single-piece construction.

7. The squeeze sprayer of claim 1 wherein said squeeze sprayer cap defines a liquid flow channel between a portion of said squeeze sprayer cap and said dip tube.

8. The squeeze sprayer of claim 7 wherein said chamber is in liquid flow communication with said liquid flow channel.

9. The squeeze sprayer of claim 8 wherein said chamber is constructed and arranged to define a flow corridor extension which is in liquid flow communication with said liquid flow channel.

10. The squeeze sprayer of claim 1 in which the valve is a diaphragm valve comprising a flexible panel with a hole through which the dip tube extends, and which engages the dip tube with a deflectable annular lip.

11. The squeeze sprayer of claim 1 in which the valve is comprised in a one-piece valve component having an annular wall secured in a channel of the squeeze sprayer cap.

12. The squeeze sprayer of claim 1 in which the valve is comprised in a valve component which encloses the entry to a liquid flow channel leading to said chamber.
